(19) United States
(12) Patent Application Publication
(10) Pub. No.: US 2008/0097935 A1
(43) Pub. Date: Apr. 24, 2008

(54) Access housing

(76) Inventor: Midred E. Boyer, Randallstown, MD (US)

Correspondence Address: Mildred E. Boyer, 3959 Whispering Meadow Drive, Randallstown, MD, 21133, US

(21) Appl. No.: 11/973,557

(22) Filed: Oct. 9, 2007

Related U.S. Application Data
(60) Provisional application No. 60/851,162, filed on Oct. 11, 2006.

(51) Int. Cl. G06Q 90/00

(52) U.S. Cl. 705/500

(57) ABSTRACT

The Applicant has invented a business model to supply housing with telecommunication and internet services supplemented with education and career training.

### i. SUMMARY

The Applicant has invented a business model to supply housing with telecommunication and internet services supplemented with education and career training.

### ii. BACKGROUND

The need for affordable rentals grows critical nationwide, as gentrification in some neighborhoods and continued deterioration in others leads to the removal of vitally needed lower-cost rental housing. The need to accommodate new investment by housing the most vulnerable renters and providing training to increase resolve to bolster their earning capacity as well as their e-readiness to survive in today's digital era is crucial, and will only worsen in the years ahead.

Rather than following a pattern that exploits the poor, the Applicant pondered scenarios and considered the social impacts in which benefits may be enhanced on a widespread basis through the actions of government as well as private stakeholders. There has also been research and anecdotal evidence that gains in employment, education, and community development are the result of technology training, and internet access.

The invention of this business model addresses the needs for shelter, greater access to information technology along with the much needed training that will bring about the self-empowerment in becoming more and more—which is essential for societal and economic purposes.

### iii. DESCRIPTION OF THE INVENTION

A. Buildings/Vehicles:

When obtaining a building or land, the user will typically follow the following scheme:

The user of the invention obtains vacant housing or land that is in need of repair and/or development. He builds new structures and rehabilitates older ones to make them habitable. The housing incorporates, within one or more of the walls, floors, ceilings, or roof, the hardware wiring and infrastructure along with telecommunication devices needed to supply power and internet access via computer, telephone and/or wireless systems.

Alternatively, the user may buy or rent a building or static structure, or land that is already habitable and modifies it to incorporate the technology equipment, wiring and infrastructure, and telecommunications devices described above.

When obtaining a vehicle or mobile structure, the user will typically follow the following scheme:

The user of the invention, will fit a motor vehicle, or a structure attached to same (e.g. a trailer, car, or truck) to incorporate the technology equipment, wiring and infrastructure, and telecommunications devices as described above.

B. Facilities:

The facilities used in the invention may be any static structure that is large enough to incorporate the technology equipment, wiring and infrastructure, and telecommunications devices described above. Kiosks, and free-standing booths may be facilities.

C. Individuals and Families:

The individuals and families who will acquire education and/or career training via use of this business model are typically individuals, parents with children, single-parent households, disabled persons, elderly persons, low-to-moderate income persons, and the like. Services are provided in exchange for federal subsidy, voucher payment, contribution, grant, and government-sponsored payment. Members may pro vide contributions towards their own support.

D. Training Centers:

At locations remote from the building, vehicles or facilities there will be training centers. These centers may have security guards and surveillance cameras with safeguarding equipment therein.

The user of the invention may lease, rent, purchase and/or franchise various types of establishments as community training centers. Among these types are churches, houses, schools, libraries, retail stores, warehouses, lamp posts, kiosks, buildings, commercial establishments, strip malls, and the like.

E. Education and Career Training:

The use of this business model provides educational, career-focused job training to individuals and families described above.

These individuals and families may also be provided matriculation and graduation services to empower them as they acquire marketable and/or self-sufficiency skills.

F. Information/Communication Systems:

The system that individuals and families will access using the business model of the invention, are designed to provide education, career training, self-empowerment, safety-filtered internet access, and the like.

Physically, these systems can employ one or more of the following (i.e. wireless platforms, network interface cards, telephone lines, local area network devices, microwave network, broadband, DSL, cable modem, radio & TV signals, satellite, cellular, and voice over internet protocol systems.

G. Technology Equipment Provided:

The user of the invention will typically equip one or more housing units with a thin client, a dummy terminal/monitor, keyboard, and mouse. This equipment is used to lessen the opportunity of theft, since once this equipment is unplugged from the housing unit—it has no meaning or value to a person who does not have access to the housing unit. This equipment is used to lessen the burden of maintenance and repair as these devices are not repaired, but replaced.

It is desirable to maximize the number of devices and communication means that can not be removed or tampered with. The maximum number of deices will depend upon the type of communication/information systems being made available to the members. For example, a connector, mouse, keypad and viewer/monitor may be the only devices that need to be physically present in the space in which the member lives and/or receives the education and/or training.

### vi. ADVANTAGES

The user of the invention's model has several advantages; including the following:
1. The removal of the technology equipment from the end-user's station has no value, or purpose to a non-member, nor is it compatible to any other data system. It can not be used as a stand-alone model.
2. The end-user's station will be provided email address and access.
3. Maintenance costs are minimal with the invention because those components that are portable/removable are more cost-effectively replaced than repaired if they are missing or they malfunction.
4. No software or hardware upgrades are needed for the end-user's stations because all upgrades will be done at the network server level.
5. Pre-paid credit cards will be provided to the end-user and can be used to pay bills and charge services.
6. Voter Registrations and can be performed from the end-user's stations.
7. Personal business and medical information can be transmitted.
8. Transportation services (e.g. taxicabs, medicinal-related transportation, etc.) can be ordered and/or monitored for locations, arrival times, etc.
9. This business model empowers all people via internet technology within our current and future digital lifestyle.
10. This business model generates tax revenues from land and vacant housing that was previously underutilized.

### v. EXAMPLES

1. The user of the invention provides housing with technology equipment, telecommunications and internet services and provides educational and career training.
2. The user of the invention requests donation or discounted pricing for models of boarded, vacant, dilapidated, and deteriorated housing and or land.
3. The user of the invention revitalizes the donated, discounted, or purchased housing with rehabilitated, pre-fabricated, renewed housing complete with wiring and infrastructure, operable telephone, technology equipment, and internet access and services.
4. The user of the invention provides municipality with generated tax revenue from land, housing, and the like.
5. The user of the invention leases, rents, purchases and franchise various types of establishments as components of local training centers. Among these types are churches, houses, schools, libraries, retail stores, warehouses, lamp posts, kiosks, buildings, commercial establishments, vehicles, strip malls, and the like.
6. The user of the invention provides security guards and surveillance cameras in local training centers and training sessions.
7. The user of the invention interviews and enrolls individuals, families, disabled persons, disadvantaged persons, elderly persons, and low-to-moderate income persons, and the like into best-suited housing models in exchange for federal subsidy, voucher payment, contribution, grant, and government-sponsored payment. Members may provide contributions toward their own support.
8. The user of the invention provides housing to member individuals, families, disabled persons, disadvantaged persons, elderly persons, and low-to-moderate income persons, and the like in exchange for federal subsidy, voucher payment, contribution, grant, and government-sponsored payment. Members may provide contributions towards their own support.
9. The user of the invention provides technology equipment, internet access and services to each housing unit using various telecommunication devices. Among these are wireless platform, WI-FI systems, wireless cards, network interface cards, telephone lines, Local Area Network devices, Microwave network, broadband, DSL, Cable Modem, Radio & TV Signals, satellite, cellular, and voice over internal protocol systems.
10. It is desirable to maximize the number of devices, technology equipment and telecommunication means that can not be removed or tampered with. The maximum number of devices will depend upon the type of communication/information systems being made available to the members. For example, a connector, mouse, keypad, thin client and viewer/monitor may be the only devices that need be physically present in
11. the space in which the members lives and/or receives the services, education and/or training.
12. The user of the invention equips each housing unit with technology equipment consisting of a thin client, a dummy terminal/monitor, keyboard and mouse. This technology equipment is used to lessen the opportunity of theft as once this technology equipment is unplugged from the housing
13. unit—it has no meaning or value to a non-member. This technology equipment is used to lessen the burden of maintenance and repair as these devices are not repaired, but replaced.
14. The user of the invention provides an email address, and internet access and internet training to members, families, disabled persons, elderly persons, low-to-moderate income persons, and the like in exchange for federal subsidy, voucher payment, contribution, grant, and government-sponsored payment. Members may provide contributions towards their own support.
15. The user of the invention provides educational, and career-focused job training to members, families, disabled persons, elderly persons, and low-to-moderate income persons, and the like in exchange for federal subsidy, voucher payment, contribution, grant, and government-sponsored payment. Members may provide contributions toward their own support.
16. The user of the invention provides matriculation and graduation services to empower members, families, disabled persons, elderly persons, and low-to-moderate income persons who display marketable and/or self-sufficiency skills.
17. Various modifications which would occur to the skilled artisan can be made in the invention without departing from its scope.
18. In one embodiment, dilapidated housing is rehabilitated to install technology equipment, including a thin client, computer terminal/monitor, keyboard and mouse. The equipment, when not installed in the housing unit, has no value. That is, persons who are non-members can derive no benefit by stealing the equipment.
19. When installed in the housing, the equipment enables members and others within the hosing to access the internet and other electronically available resources in order to acquire training and skills that increase their self-sufficiency.
20. Because there are residents in the rehabilitated housing, the housing has increased value and can generate tax revenue. Also, the residents will, because of their training, have more valuable skill-sets.

I claim:

1. A business model to supply housing, telecommunication, and internet services combined with educational and/or career training to individuals and families in need thereof including the following steps:
A. Obtaining a building, facility or vehicle capable of enclosing or serving as a physical support, housing or infrastructure platform for the devices used to supply telecommunication and internet services; and
B. Equipping the building, facility or vehicle with infrastructure, telecommunication devices, communications devices, hardware equipment, and other related services; and
C. Giving individuals and families that this business model serves access to the equipped building, facility or vehicle of Step B, so they will acquire education and/or career training using internet technologies, instructor-led classroom training, and hands-on training that help them become empowered, marketable, and/or self-sufficient.

2. The business model of claim 1 wherein one or more of the devices used in Step A is made available to the individuals or families in a way that makes the devices impossible to remove or tamper with.

3. The business model of claim 1 wherein the devices used in Step A involve a maximum number of devices that can not be removed or tampered with.
